(19) United States
(12) Patent Application Publication
(10) Pub. No.: US 2011/0320656 A1
(43) Pub. Date: Dec. 29, 2011

(54) Techniques for obtaining a serial number for a storage device

(75) Inventor: Yudi Cao, Beijing (CN)

(73) Assignee: Vimicro Corporation

(21) Appl. No.: 13/225,519

(22) Filed: Sep. 5, 2011

Related U.S. Application Data
(63) Continuation of application No. PCT/CN2010/073989, filed on Jun. 21, 2010.

(51) Int. Cl. G06F 13/42

(52) U.S. Cl. 710/106

(57) ABSTRACT

Technique for adding a serial number to a memory or storage device (e.g., a USB device) is disclosed. In one embodiment, the technique includes: generating a serial number after a host computer identifies a storage device connected thereto; transmitting the serial number to the storage device by the host computer via a driver; and saving the serial number being received to the storage device. The invention also discloses a host computer providing a serial number to a storage device and a storage device obtaining a serial number from the host computer.

### CROSS-REFERENCE TO RELATED APPLICATION

This application is a continuation of International Application No. PCT/CN2010/073989, filed Jun. 21, 2010.

### BACKGROUND OF THE INVENTION

1. Field of the Invention

The invention relates to embedded computer system, particularly, to a technique for obtaining a serial number for a storage device (e.g., a USB device), where the technique can be realized as a method, and implemented in a host computer or a memory device.

2. Description of Related Art

With the rapid development of computer hardware, an increasing number of peripheral devices, e.g., keypads, pointing devices, modems, printers, and scanners, are commonly known and widely used. Digit cameras and MP3 players have been also taken their places. Those peripheral devices need some interfaces to be connected to personal computers. USB, standing for Universal Serial Bus, is an interface used for connecting the peripheral devices to a personal computer. USB makes the connection of the peripheral devices to the computer standardized and simplified. A device that uses the USB interface to connect to a computer can be called a USB device.

A USB device shall have a serial number in a USB protocol. The serial number serves to uniquely identify the USB device from possible peripherals. During manufacturing USB devices, a manufacturer would program different serial numbers for all USB devices. However, the programming of the serial numbers for USB devices is of high cost.

In order to reduce the cost, the manufacturer usually does not provide a serial number for a USB device. Namely, the serial number of the USB device is null, which causes inconvenient in practical applications. For example, when a USB device is connected to a USB interface A, a host computer can identify the USB device and load a corresponding driver. However, if the USB device turns to be connected to a USB interface B, the host computer is required to identify the USB device again and load its corresponding driver.

### SUMMARY OF THE INVENTION

In general, the present invention is related to writing a generated serial number into a memory device. Specifically, various embodiments of the present invention provide technique for obtaining a serial number for a memory device and writing the serial number into the device via a driver. Any of the embodiments can be easily implemented with low cost.

The present invention may be implemented as a method, an apparatus or a part of a system. According to one embodiment, the present invention is a method for obtaining a serial number for a USB device, the method comprises generating a serial number in a host computer after the host computer identifies a USB device connected thereto; transmitting the serial number from the host computer to the USB device via a driver; and causing the USB device to save the serial number being received therein.

According to another embodiment, the present invention is a host computer comprising a generating module configured to generate a serial number during a test phase; a USB interface module configured to connect a USB device; and a driver module configured to transmit the serial number to the USB device via a driver and cause the USB device to save the serial number being received.

According to another embodiment, the present invention is a USB device comprising a USB interface module configured to connect the USB device to a host computer and receive a serial number transmitted from the host computer via a driver, a memory module configured to store data; and a running module configured to extract the serial number from the driver and store the serial number to the memory module, wherein the serial number is generated in the host computer to uniquely identify the USB device.

The USB device in one embodiment of the invention receives and stores the serial number transmitted from the host computer, thereby obtaining the serial number. The host computer can be connected to a plurality of USB devices and transmit respective serial numbers to the USB devices, thereby benefiting mass production.

### BRIEF DESCRIPTION OF THE DRAWINGS

FIG. 1 is a schematic block diagram of a system in an embodiment of the invention.

FIG. 2 is a main flowchart of a method for obtaining a serial number of a USB device in an embodiment of the invention.

FIG. 3 is a detailed flowchart of a method for obtaining a serial number of a USB device in an embodiment of the invention.

FIG. 4 is a detailed flowchart of a method for obtaining a serial number of a USB device with a process for verifying a mark bit in an embodiment of the invention.

FIG. 5 is a schematic block diagram of a host computer in an embodiment of the invention.

FIG. 6 is a schematic block diagram of a USB device in an embodiment of the invention.

### DETAILED DESCRIPTION OF THE INVENTION

In an embodiment of the present invention, a serial number is generated by a host computer and transmitted to a USB device via a driver, thereby enabling the USB device to obtain the serial number. Thus, the USB device is equipped with a serial number. The cost in design and mass manufacturing of such a USB device is lower.

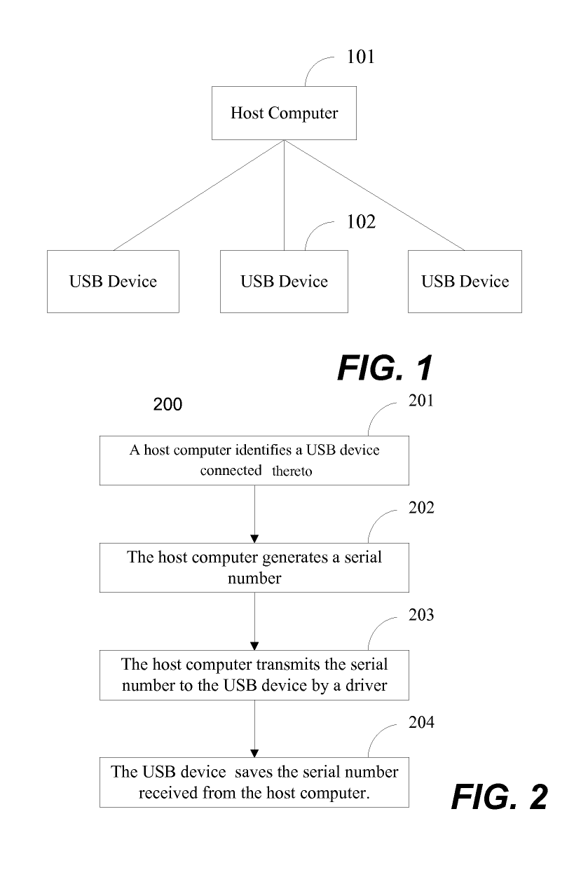

Referring to FIG. 1, it shows an exemplary system in which a host computer 101 is provided to work with a plurality of USB devices. The host computer 101 is configured to run programs and connected to one of the USB devices 102 via a USB interface, and tests the USB device 102 as well. The host computer 101 generates a serial number in a test phase, transmits respective serial numbers to the USB device 102, and directs the USB device 102 to store the serial number being received.

The USB device 102 is connected to the host computer 101 via the USB interface and functions as a peripheral device to implement a given function. The USB device 102 receives the serial number transmitted through the driver, parses the serial number, and stores the serial number. Understandably, the host computer 101 can be simultaneously connected to a plurality of USB devices, generate different serial numbers for the USB devices, and respectively transmit the serial numbers to all the USB devices.

Referring to FIG. 2, there shows a flowchart or process 200 for obtaining a serial number in a USB device according to one embodiment of the present invention.

At 201: The host computer 101 identifies a USB device 102 connected thereto. During the identifying process, the host computer 101 can identify the USB device 102 by scanning all USB interfaces. The identification of the USB device 102 can also be triggered by hardware means, e.g., transmitting an electrical level signal. The host computer 101 identifies the USB device 102 according to the electrical level signal.

At 202: The host computer 101 generates a serial number. The generation of the serial number by the host computer 101 can be implemented by various ways, such as randomly generated different serial numbers by way of generating uniform random numbers, or generating serial numbers in ascending or descending order. There are many other ways of generating a serial number known to those skilled in the art.

At 203: The host computer 101 transmits the serial number to the USB device 102 by a driver. The driver can be a device driver program of the USB device 102.

At 204: The USB device 102 saves the serial number received from the host computer 101.

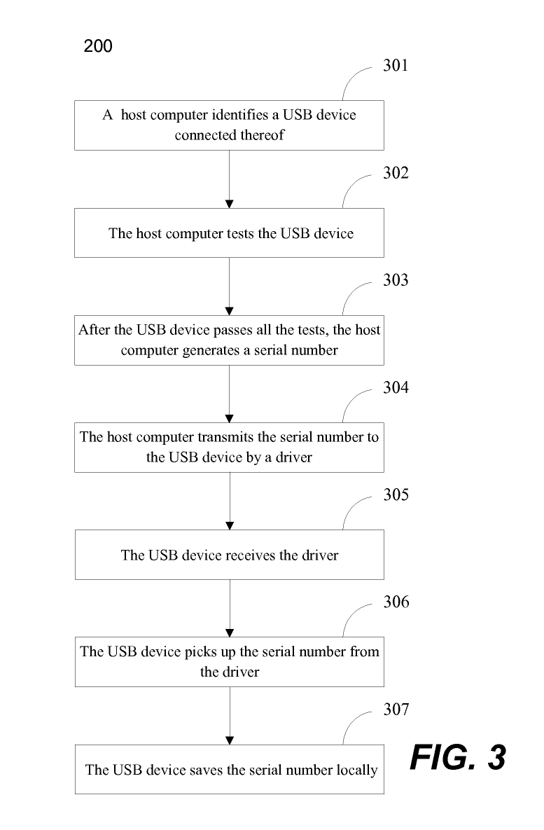

Referring to FIG. 3, it shows a flowchart or process 300 for obtaining a serial number in a USB device according to one embodiment of the present invention.

At 301: The host computer 101 identifies a USB device 102 connected thereto.

At 302: The host computer 101 tests the USB device 102.

At 303: After the USB device passes all tests, the host computer generates a serial number. The serial number not only uniquely marks the USB device 102, but also marks that the USB device 102 is a qualified product because the serial number is generated when the USB device passes the test. If the USB device 102 fails to pass the tests, the USB device should undergo a debugging operation.

At 304: The host computer 101 transmits the serial number to the USB device 102 by a driver.

At 305: The USB device 102 receives the driver.

At 306: The USB device 102 picks up the serial number from the driver.

At 307: The USB device 102 saves the serial number locally.

According to one embodiment, the serial number is generated at a test phase and saved to the USB device 102. There is no need to program a serial number for each USB device at a manufacturing phase, thereby reducing the cost. The USB device in one embodiment has a function to pick up the serial number from the driver and locally save the serial number. A module for implementing the function is programmed in the USB device 102 during manufacturing, As such, the USB device 102 can be manufactured in volume with low cost.

During designing the USB device, a mark bit may be provided for the USB device 102 and configured to denote whether the serial number has been set or updated. For example, the mark bit is “0”, which denotes that the serial number is not set or updated; the mark bit is “1”, which denotes that the serial number has been set or updated.

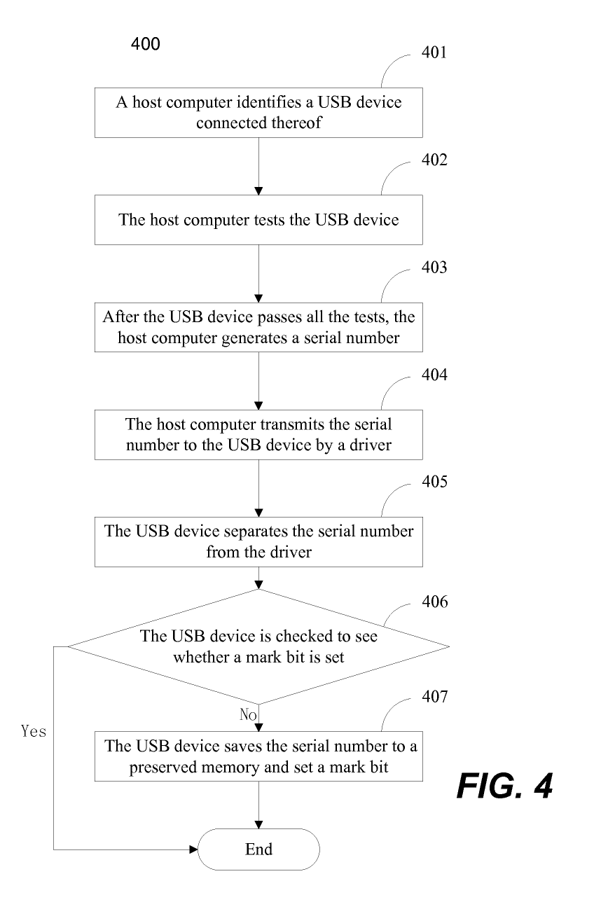

Referring to FIG. 4, it shows a process 400 for obtaining a serial number of a USB device with a verifying process of a mark bit according to one embodiment of the present invention.

At 401: The host computer 101 identifies a USB device 102 connected thereto.

At 402: The host computer 101 tests the USB device 102.

At 403: After the USB device passes all the tests, the host computer generates a serial number.

At 404: The host computer 101 transmits the serial number to the USB device 102 by a driver.

At 405: The USB device 102 separates the serial number from the driver.

At 406: The USB device 102 is checked to see whether a mark bit is set. If the USB device 102 has a mark bit set therein, the process ends; or else, the process goes to 407. The operation 406 serves to avoid a repeated set of the mark bit.

At 407: The USB device saves the serial number to a preserved memory and sets a mark bit. The preserved memory may be previously configured during the designing and manufacturing of the USB device 102. Thus, the USB device has a permanent memory space to save the serial number, which enables the serial number to be not easily modified or canceled by subsequent operations.

The preserved memory space can be set by configuring an initial value for the serial number. Preferably, the serial number generated by the host computer 101 is different from the initial value. The USB device 102 may further determine whether the serial number picked up from the host computer is different from the initial value. If the serial number is the same as the initial value, the USB device 102 returns a responding message to the host computer to request a serial number again. If the serial number is different from the initial value, the USB device 102 saves the serial number to the site that the initial value is located at, i.e., the initial number is updated to the serial number. As such, the mark bit is not necessary. However, the preserved memory space may function as the mark bit. If the serial number saved in the preserved memory space is the initial value, it may equate that a mark bit is not set. If the serial number saved in the preserved memory space is not the initial value, it may equate that a mark bit has been set.

At 405 and 406, the USB device 102 is triggered by the separated serial number to check whether the mark bit is set. The host computer may also insert a configuration symbol of the serial number into the driver. The USB device 102 picks up the configuration symbol of the serial number, then separates and saves the serial number, without checking whether the mark bit has been set.

Above description is detailed for the embodiment of the system and the method. The method is carried out by the host computer 101 and the USB device 102. Constructions and the functions of the host computer 101 and the USB device 102 are detailed as follows.

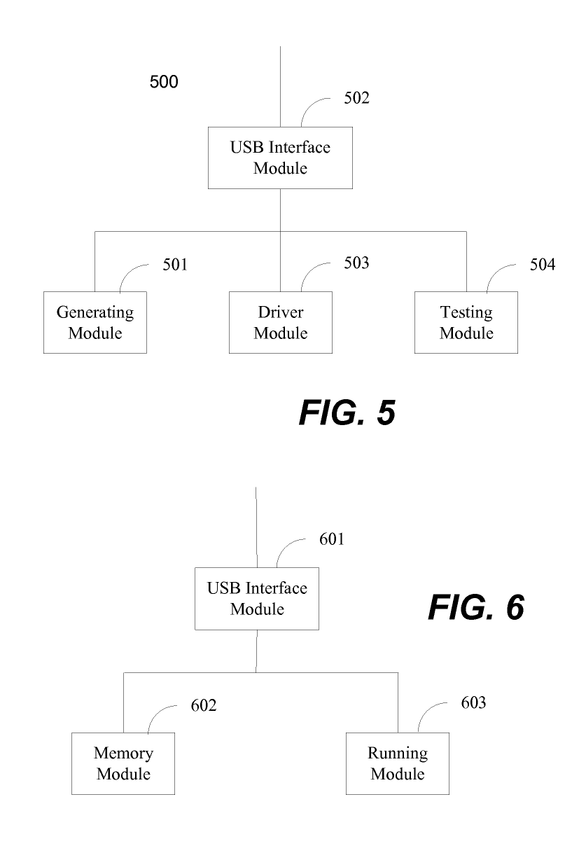

Referring to FIG. 5, it shows a functional diagram of a host computer corresponding to the host computer 101 of FIG. 1 that includes a generating module 501, a USB interface module 502, and a driver module 503. The generating module 501 is configured to generate a serial number during the testing phase. The USB interface module 502 is configured to connect the USB device. The driver module 503 is configured to transmit the serial number to the USB device with the driver and request the USB device to save the serial number being received.

The host computer 101 further includes a testing module 504 configured to test the USB device. The generating module 501 generates a serial number after the USB device passes all the tests during the testing phase.

Referring to FIG. 6, it shows an exemplary a USB device corresponding to the USB device 102 of FIG. 1. The USB device includes a USB interface module 601, a memory module 602, and a running module 603.

The USB interface module 601 is configured for connecting the host computer 101 and receiving the serial number with the driver transmitted by the host computer 101.

The memory module 602 is configured to store data. The running module 603 is configured to separate the serial number from the driver and store the serial number to the memory module 602. The running module 603 is also configured to check whether a preset mark bit has a serial number set therein and store the serial number being received to the memory module when the serial number is not set. The serial number being received is stored to an appointed site of the memory module. During designing and manufacturing the USB device, a memory space on the USB device is preserved for the serial number. The preserved memory space is the appointed site.

Programs for implementing the embodiments of the present invention can be stored in any one of floppy disks, hard disks, compact disks, or flash memories. The USB device in the embodiments of the present invention receives and stores the serial number transmitted by the host computer. The process for obtaining the serial number is simple and of low cost. The host computer can be connected to a plurality of USB devices and transmit serial numbers for the plurality of USB devices, which benefits mass production of the USB devices. Further more, in the embodiments of the present invention the serial number is transmitted to the USB device after the USB device passes the tests, which not only implements the unique identify of the USB device, but also denotes that the USB device is qualified. The embodiments of the present invention can be employed to mass manufacture the USB device and benefit reduction of cost. In addition, in the embodiments of the present invention the USB device stores the serial number to an appointed site. The serial number is not easily modified and improves safety.

It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for obtaining a serial number for a memory device, the method comprising:
generating a serial number in a host computer after the host computer identifies a storage device connected thereto;
transmitting the serial number from the host computer to the storage device via a driver; and
causing the storage device to save the serial number being received therein.

2. The method as claimed in claim 1, wherein said generating a serial number in a host computer comprises: generating the serial number only after tests on the storage device performed by the host computer are passed.

3. The method as claimed in claim 1, wherein before the storage device saves the serial number being received, the host computer is configured to check whether a preset mark bit has a serial number set therein, and store the serial number to a memory module in the storage device when the serial number is not set yet.

4. The method as claimed in claim 1, wherein said causing the storage device to save the serial number being received therein comprises: causing the storage device to save the serial number being received in a predefined memory space.

5. The method as claimed in claim 4, wherein the storage device is caused to update an initial value preset for the serial number to the serial number being received.

6. The method as claimed in claim 4, wherein the storage device is a USB device.

7. A host computer comprising:
a generating module configured to generate a serial number during a test phase;
a USB interface module configured to connect a USB device; and
a driver module configured to transmit the serial number to the USB device via a driver and cause the USB device to save the serial number being received.

8. The host computer as claimed in claim 7, further comprising a test module configured to test the USB device, wherein the generating module is configured to generate the serial number when tests on the USB device conducted by the test module are passed during the test phase.

9. A USB device comprising:
a USB interface module configured to connect the USB device to a host computer and receive a serial number transmitted from the host computer via a driver, wherein the serial number is generated in the host computer to uniquely identify the USB device;
a memory module configured to store data; and
a running module configured to extract the serial number from the driver and store the serial number to the memory module.

10. The USB device as claimed in claim 9, wherein the running module is further configured to check whether a preset mark bit has an initial serial number set therein and store the serial number to the memory module when the initial serial number is not set.

11. The USB device as claimed in claim 9, wherein the running module stores the serial number being received to an appointed site of the memory module.

12. The USB device as claimed in claim 11, wherein the running module updates the initial serial number to the serial number being received.
